(19) United States
(12) Patent Application Publication
(10) Pub. No.: US 2023/0196011 A1
(43) Pub. Date: Jun. 22, 2023

(54) Data Augmentation and Adaptive Curriculum Learning for Sentence-level Relation Extraction

(71) Applicant: Robert Bosch GmbH, Stuttgart (DE)

(72) Inventors: Ashim Gupta, Salt Lake City, UT (US); Jun Araki, San Jose, CA (US); Heike Adel-Vu, Stuttgart (DE)

(21) Appl. No.: 17/555,419

(22) Filed: Dec. 18, 2021

(51) Int. Cl. G06F 40/205; G06N 20/00

(52) U.S. Cl. CPC G06F 40/205; G06N 20/00

(57) ABSTRACT

Methods for training a relation extraction model include using dependency parsing, constituency parsing, and lexically constrained paraphrasing to augment the training data for the model. Adaptive curriculum learning is used to train the model using the augmented training data such that different scoring functions are used at different levels of training to order the training data for the curriculum learning.

### TECHNICAL FIELD

This invention is related to the field of natural language processing (NLP) and information extraction (IE).

### BACKGROUND

Information Extraction (IE) aims at structuring and organizing information resources as acquired knowledge from unstructured text, thereby enabling efficient and effective utilization of the information in downstream applications (e.g., question answering). The output of IE often results in (subject, relation, object) triples, and they form an atomic unit of knowledge in a knowledge graph. Partly because of this knowledge base formulation, IE is often considered comprising two tasks: entity detection and relation extraction. Entity detection aims at recognizing entity mentions in text and deciding their types. For example, given a sentence “Joe Biden is the president of the United States.”, entity detection is expected to detect two entity mentions “Joe Biden” with type ‘Person’ and “United States” with type ‘Location’ (or ‘Country’). Relation extraction aims at detecting relations between two entity mentions. This invention focuses on relation extraction, with entity mentions already given in text.

Relation extraction is widely studied in the field of Natural Language Processing (NLP). As with other NLP tasks, state-of-the-art for relation extraction employs deep learning models, e.g., Long Short-Term Memory (LSTM) networks and Transformers, mainly because they were shown to achieve high performance in some benchmark datasets, as compared to prior models, such as rule-based or traditional feature-rich machine learning models. The benchmark datasets (e.g., a set of sentences or documents annotated with predefined labels of relations) are created in some domains. Because these existing domains and labels do not necessarily match domains or labels of interest, deep learning models trained on the datasets are not directly applicable to a particular domain-specific task of our interest. Therefore, it is necessary to have our own dataset with sentences and labels of interest for model training.

The main disadvantage of such supervised deep learning models is that they rely on a large amount of manually labeled data for supervision. A small amount of training data is not sufficient, because it is likely for the models to overfit the small data and not generalize well. However, creating a large amount of human-curated training data is often difficult because human-annotation of sentences by domain experts is expensive in practice. Therefore, generalizing deep learning models without relying on a large amount of manually annotated data is an important problem for NLP tasks including relation extraction.

Data augmentation is often used to increase the amount of samples in a training data set. The basic idea is that given a small set of training examples, data augmentation generates new synthesized examples from the original training data. Data augmentation is quite common and widely used for images in studies on computer vision, because some simple operations (flipping, rotating, cropping, etc.) have been shown to be effective. However, these kinds of intuitive operations are not readily available for text due to its discrete nature. Unlike a pixel in an image, changing a single word can significantly change the meaning of a phrase or a sentence.

### SUMMARY

According to one embodiment, a computer-implemented method for training a relation extraction model using data augmentation of training data includes receiving an original labeled sentence as input, the labeled sentence including entities and at least one relation. A dependency parsing process is used on the labeled sentence to generate first augmented training data. A constituency parsing process is used on the labeled sentence to generate second augmented training data. A scoring function is used to order a training set based on difficulty. The training set includes the original labeled sentence, the first augmented training data, and the second augmented training data. A curriculum learning process is then used to train the relation extraction model by feeding the scored training set to the machine learnable model. The trained relation extraction model is then stored in a memory.

According to another embodiment, a computer-implemented method for training a relation extraction model using data augmentation of training data includes receiving an original labeled sentence as input, the labeled sentence including entities. A lexically constrained paraphrasing process is then used on the labeled sentence to generate first augmented training data. A scoring function is used to order a training set based on difficulty. The training set includes the original labeled sentence and the first augmented training data. A curriculum learning process is then used to train the relation extraction model by feeding the scored training set to the machine learnable model. The trained relation extraction model is then stored in a memory.

According to yet another embodiment, a computer-implemented method for training a machine learnable model using data augmentation of training data includes receiving an original labeled sentence as input, the labeled sentence including entities. At least one of a dependency parsing process, a constituency parsing process, and a lexically constrained paraphrasing process is then used on the labeled sentence to generate augmented training data. A first scoring function is selected from a plurality of scoring functions to order a training set based on difficulty. The relation extraction model is then trained using a curriculum learning process by feeding the scored training set to the relation extraction model in an order determined by the selected scoring function to generate an intermediate model. A respective performance metric is determined for each of the scoring functions in the plurality by evaluating a performance of the intermediate model using a validation data set ordered respectively by the plurality of scoring functions. Another scoring function is then selected from the plurality of scoring functions to order the training data based on difficulty. The another scoring function is selected based on the determined performance metric of the second scoring function. The relation extraction model is then trained again using the scored training set data from the another scoring function.

### BRIEF DESCRIPTION OF THE DRAWINGS

FIG. 1 shows an exemplary original labeled sentence used as input to the data augmentation system and the augmented data generated from the original labeled sentence using the data augmentation methods described herein.

FIG. 2 is a block diagram showing the augmented data generating system in accordance with the present disclosure.

FIG. 3 is an exemplary constituency parse tree generated from the original labeled sentence of FIG. 1.

FIG. 4 is an exemplary dependency parse tree generated from the original labeled sentence of FIG. 1.

FIG. 5 is a schematic illustration of the adaptive curriculum learning system of the present disclosure.

FIG. 6 is a flowchart of an adaptive curriculum learning process of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to a person of ordinary skill in the art to which this disclosure pertains.

As mentioned in the previous section, data augmentation for textual tasks is not straightforward. The augmentation for relation extraction data is especially challenging and still understudied. One particular challenge is that the augmentation methods need to preserve the entity mentions in the original sentence as well as the textual statement of the relationship between them. This disclosure is directed to data augmentation strategies for the task of extracting sentence-level relations between provided entity mentions. Note that the relationship manifested in a sentence is specific to the (typically two) entity mentions involved. The data augmentation methods described herein are intended to satisfy two constraints: (1) preserving the entity mentions, and (2) preserving the relationship between them. In this disclosure, two simple yet effective strategies for data augmentation are proposed that satisfy the two aforementioned constraints. The first methodology makes use of a simple intuition that often, for a large sentence, the relationship exhibited between two entities can be captured by a smaller span of the original sentence. The second strategy is based on paraphrasing the original text in which these constraints are fulfilled by additionally making use of lexically-constrained decoding on neural paraphrase systems (explained in more detail below).

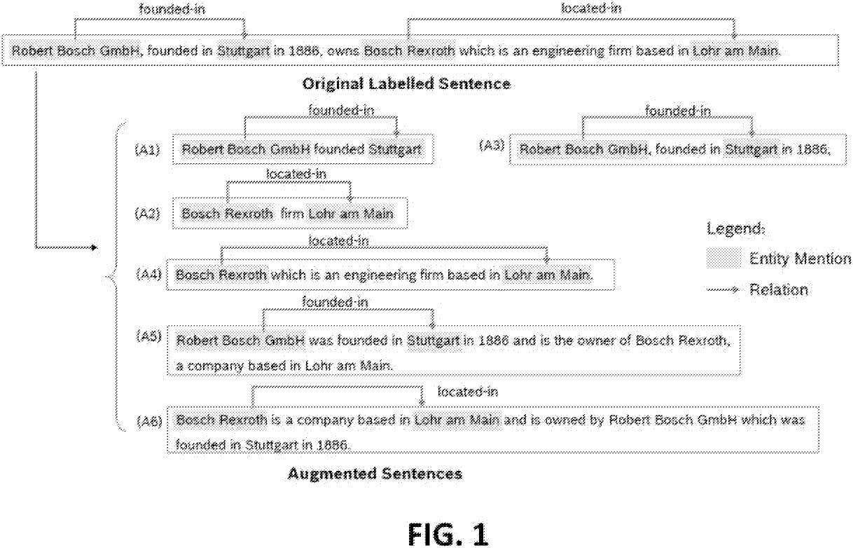

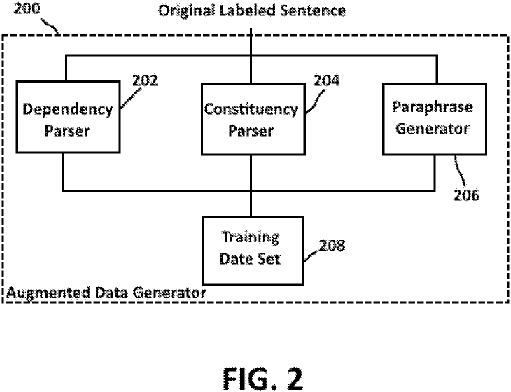

An embodiment of an augmented data generator 200 for generating augmented data samples is depicted in FIG. 2. Given a labeled example - a sentence with two entity mentions and a label as depicted in FIG. 1- the proposed framework uses different syntactic parsing methods to generate new examples (A1-A6, FIG. 1). For a given sentence, the method aims at selecting a smaller portion of the same sentence that exhibits the same relation between two entity mentions. The newer example, thus generated, is simpler and easier for a learning model to understand. Referring to FIG. 2, to perform this operation, two of the most common methods of syntactic parsing of sentences, namely syntactic dependency parsing 202 and constituency parsing 204, may be used. Each of these methods take as input a list of words in a sentence and represent the sentence in the form of a tree structure. Following this, dependency parsing and constituency parsing algorithms are used for selecting a part of this tree to construct final augmentation examples. These two parsing algorithms are used because their parsing results are structurally different, and data augmentation based on them can generate disparate examples.

Dependency parsing makes use of graph-based dependency parsing of sentences. Given a sentence as input, this method first constructs a weighted, fully-connected graph between all words in the sentence and then constructs a tree by extracting a maximum spanning tree from this graph. For the purposes of this disclosure, it is assumed that the most important information concerning the relation between the two entity mentions is contained on the Shortest Dependency Path (SDP) connecting the two entities in this tree. Therefore, all the words located on the SDP connecting two entities from the dependency tree of the sentence are selected.

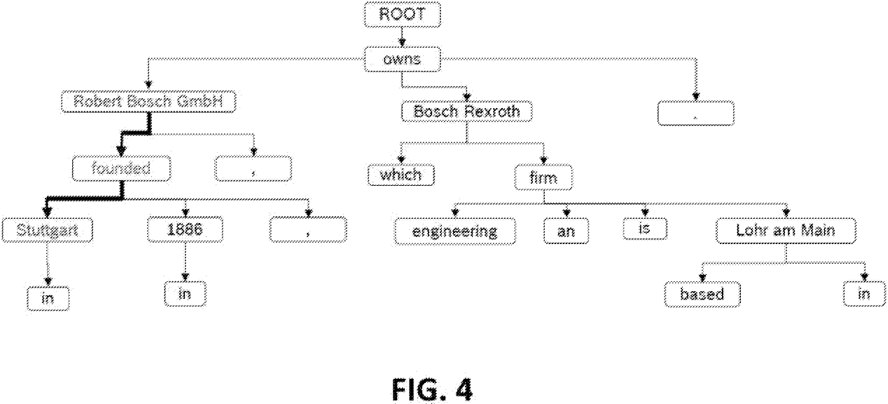

As an illustration, please consider the example from FIG. 1, for which the dependency parse tree is drawn in FIG. 4. The shortest dependency path connecting the two entities of interest, i.e. ‘Robert Bosch GmbH’, and ‘Stuttgart’ in this example, are highlighted by with bold interconnecting lines. In order to make the generated sentence more fluent, the words are restored in their original order of occurrence. Generated examples from this procedure are shown in FIG. 1 (examples A1, and A2).

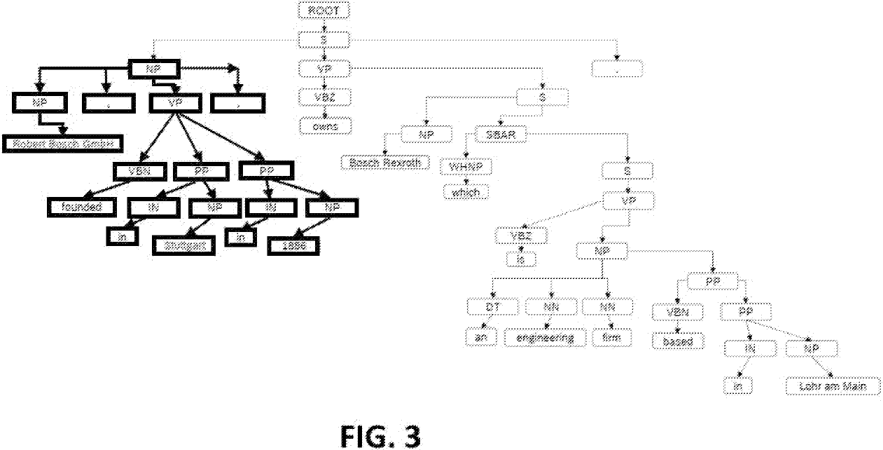

Referring to FIG. 2, constituency parsing 204 makes use of phrase-structure grammar to generate a simplified augmentation example. In this method, a constituency parse tree (e.g., based on Phrase Structure Grammar) is first constructed for the original sentence. For the example shown in FIG. 1, the corresponding constituency parse tree is shown in FIG. 3.

For the purposes of the disclosure, it is assumed that, in a constituency parse tree, the most relevant information for the concerned relation is contained in the sub-tree rooted at the lowest common ancestor (LCA) of the two entity mentions in the tree. In the example, for the two entities - ‘Robert Bosch GmbH’, and ‘Stuttgart’ - this process essentially selects the sub-tree containing the words ‘Robert Bosch GmbH, founded in Stuttgart in 1886,’ (highlighted with bold lines in FIG. 3). Note that, performing this operation simplifies the sentence considerably by getting rid of the irrelevant words in the later part of the sentence. A possible implication of using such simplification is that a learning model could find it easier to learn from simpler sentences as compared to the more complicated original ones. The examples produced by this strategy are shown in FIG. 1 (A3, and A4).

Referring again to FIG. 2, additional augmentation examples may be generated via paraphrasing 206. Most commonly, the paraphrased examples change the original sentence both lexically and structurally. For instance, for the sentence ‘Volkmar Denner succeeded Franz Fehrenbach’, a possible output from a paraphraser might be ‘Franz Fehrenbach is superceded by Volkmar Denner’, changing the active voice to the passive one and introducing ‘superceded’ as a synonym of ‘succeeded’. Using such a paraphraser might not work for relation extraction as the paraphrase might change/replace the words inside the entities.

To enable effective use of paraphrasing as a data augmentation strategy for relation extraction, lexically constrained decoding with the prevailing neural paraphrasing models is used. This approach enables retention of the original entity mentions while paraphrasing other parts of the same sentence. Common paraphrase systems use a neural sequence-to-sequence framework for generating the additional paraphrased sentences. In these frameworks, the original sentence is fed as a sequence to the input and the output sequence is decoded one-word-at-a-time using a procedure called Beam Search, which maintains a best-k list of most likely sequence outputs. Lexically constrained modifies this procedure so that the best-k list contains only those sequences that satisfy the required lexical constraints. In the framework described herein, original entity mentions are used as the lexical constraints.

In one embodiment, the method used for paraphrasing the original sentence is back-translation, although the proposed framework is general and can be applied to any paraphraser that makes use of Beam Search for decoding. A back-translation model uses two textual translation models, called a forward translation model, and a backward translation model, for obtaining the paraphrase of a sentence. In essence, such a model first translates the sentence in an original language (e.g, English) to one of the foreign languages (e.g., German) using the forward model and then translates back to the original language using the backward model. The examples illustrating lexically constrained paraphrasing are shown as A5 and A6 in FIG. 1. Recall that the lexical constraints for the examples are the corresponding entities involved in the relation.

As depicted in FIG. 2, once additional augmentation examples have been generated using the dependency parser 202, constituency parser 204, and the paraphraser 206, the augmentation examples and the original labeled sentence are combined into a training data set 208 for use in training the relation extraction model.

Once the augmented training data has been generated, the relation extraction model may be trained using the augmented training data. In accordance with the present disclosure, a curriculum learning process is used to train the model. Similar to established curriculums in human teaching, curriculum learning aims to provide a structure to the training set that can aid the model during the training process. For instance, feeding easier examples under a curriculum at the start (or the end) might improve the generalization performance of the model. One important challenge in developing an effective curriculum for any training model is the selection of a scoring function. The scoring function determines the order in which the examples from the training set are fed to the learning model - the examples with higher scores are introduced later in training.

However, it may be difficult to determine a fixed order of examples in the case of data-augmented relation extraction. On one hand, the proposed parsing-based augmentation provides simpler examples for the model to learn, but on the other hand, they might also introduce some noise into the training examples. Thus, the easiness of examples can change, depending on a particular dataset and a particular model during the training stage. Therefore, it is proposed herein that the scoring function be determined adaptively to the dataset and the model. In particular, a novel adaptive curriculum learning framework is proposed that, instead of a single scoring function, adaptively chooses a scoring function during different stages in the training process. Such a framework is additionally useful when there is no single scoring function that suits multiple different datasets of interest.

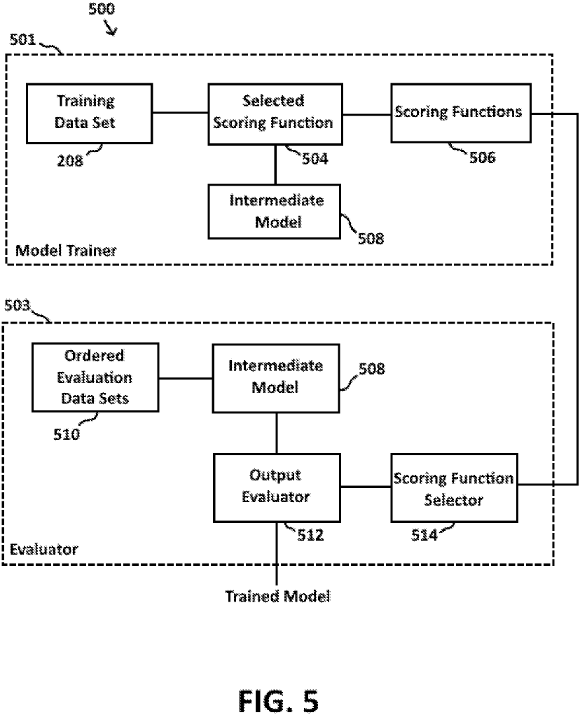

A schematic illustration of a training system 500 for training the relation extraction model is depicted in FIG. 5. The system 500 includes a model trainer 501 and a model evaluator 503 which are configured to implement the adaptive curriculum training scheme in accordance with the present disclosure. The model trainer 501 is configured to use the augmented training data set 208 generated as described above and a set of different scoring functions 506. For the task of relation extraction, the set of scoring functions 506 may contain the following functions: the distance between the two entities, the length of the sentence, word rarity of the sentence, perplexity of the sentence, and the like. In accordance with the adaptive curriculum learning process disclosed herein, different scoring functions are used at different stages of the training.

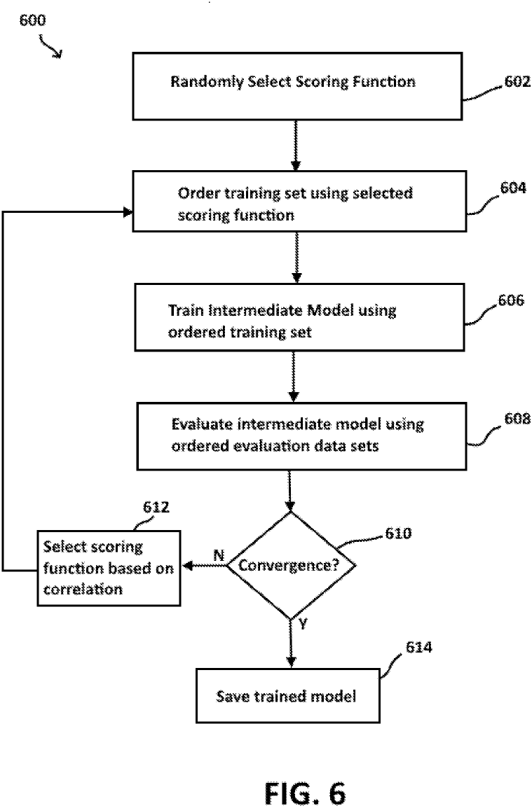

Referring to FIG. 6, a flowchart of an adaptive curriculum learning process 600 is depicted. According to the process, one of the scoring functions (506, FIG. 5) is selected at random to start (block 602). The selected scoring function (504, FIG. 5) is then used to order the training set data 208 based on difficulty (block 604) in a manner known in the art. The model is then trained using the ordered training set data (block 606) to generate an intermediate trained model (508, FIG. 5). The intermediate model 508 is then evaluated based on performance (block 608).

Referring to FIG. 5, the performance of the intermediate model 508 is evaluated by the model evaluator 503 which is configured to make use of a validation data set. As part of the adaptive curriculum learning process, the validation data set is ordered by the different scoring functions 506 to generate a plurality of different ordered validation data sets 510. The model evaluator 503 is configured to evaluate the performance of the intermediate model 508 by feeding the ordered validation data sets 510 to the intermediate model 508 and to score the results using the output evaluator 512. The output evaluator 512 may be configured to use any suitable scoring metric or function to determine a performance score for the output of the intermediate model. A scoring function selector 514 is then configured to determine a correlation between the scoring function used to order the validation data for a given iteration and the performance score achieved by the intermediate model for that iteration. In one embodiment, the scoring function selector 514 is configured to select a next scoring function for ordering the training data set that is the most negatively correlated, using the assumption that a larger negative correlation corresponds to a better ordering of examples. For example, since the validation data sets are ordered by difficulty according to the different scoring functions, a positive correlation would be that the performance of the intermediate model decreases as the difficulty of the samples increases. Conversely, a negative correlation would mean that the performance of the model increases. Selecting the scoring function that is the most negatively correlated means that the scoring function is selected that has a performance that decreases the least as the difficulty of the samples increases.

The selected scoring function is then communicated to the model trainer which uses the selected scoring function to order the training data set and then train the intermediate model again using the new ordered training data set. This process is repeated until convergence of the model is determined. As is known in the art, a machine learning model reaches convergence when it achieves a state during training in which loss settles to within an error range around the final value. In other words, a model converges when additional training will not improve the model. The output evaluator 512 is configured to evaluate the task performance to determine whether convergence of the model has occurred. Referring to FIG. 6, as part of the process, the output evaluator is configured to determine whether convergence of the model has occurred. If the model has converged, the model is considered trained and is stored as a trained relation extraction model (block 614). If the model has not converged, the next scoring function is selected (block 612) and the process is returned to block 614 where the selected scoring function is used to order the training data set.

The augmented data generator 200 and adaptive curriculum learning system 500 may be implemented by a computer system which comprises one or more processors and associated memories that cooperate together to implement the operations discussed herein. These components can interconnect with each other in any of a variety of manners (e.g., via a bus, via a network, etc.). For example, the computer system can take the form of a distributed computing architecture where one or more processors implement the various tasks described above. The one or more processors may comprise general-purpose processors (e.g., a single-core or multi-core microprocessor), special-purpose processors (e.g., an application-specific integrated circuit or digital-signal processor), programmable-logic devices (e.g., a field programmable gate array), etc. or any combination thereof that are suitable for carrying out the operations described herein. The associated memories may comprise one or more non-transitory computer-readable storage mediums, such as volatile storage mediums (e.g., random access memory, registers, and/or cache) and/or non-volatile storage mediums (e.g., read-only memory, a hard-disk drive, a solid-state drive, flash memory, and/or an optical-storage device). The memory may also be integrated in whole or in part with other components of the system. Further, the memory may be local to the processor(s), although it should be understood that the memory (or portions of the memory) could be remote from the processor(s), in which case the processor(s) may access such remote memory through a network interface. The memory may store software programs or instructions that are executed by the processor(s) during operation of the system . Such software programs can take the form of a plurality of instructions configured for execution by processor(s). The memory may also store project or session data generated and used by the system.

The system may include an input/output (I/O) interface that may be configured to provide digital and/or analog inputs and outputs. The I/O interface may include additional serial interfaces for communicating with external devices (e.g., Universal Serial Bus (USB) interface). The system 102 may also include a human-machine interface (HMI) device that may include any device that enables the system to receive control input. Examples of input devices may include human interface inputs such as keyboards, mice, touchscreens, voice input devices, and other similar devices. The system may include a display device. The system may include hardware and software for outputting graphics and text information to the display device. The display device may include an electronic display screen, projector, printer or other suitable device for displaying information to a user or operator. The system may be further configured to allow interaction with remote HMI and remote display devices via the network interface device.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A computer-implemented method for training a relation extraction model using data augmentation of training data, the method comprising:
receiving an original labeled sentence as input, the labeled sentence including entities and at least one relation;
using a dependency parsing process on the labeled sentence to generate first augmented training data;
using a constituency parsing process on the labeled sentence to generate second augmented training data;
using a scoring function to order a training set, the training set including the original labeled sentence, the first augmented training data, and the second augmented training data;
using a curriculum learning process to train the relation extraction model by feeding the scored training set to the machine learnable model; and
storing the trained relation extraction model in a memory.

2. The computer-implemented method of claim 1, further comprising:
using a lexically constrained paraphrasing process on the labeled sentence to generate third augmented training data,
wherein the training set includes the original labeled sentence, the first augmented training data, the second augmented training data, and the third augmented training data.

3. The computer-implemented method of claim 2, wherein the lexically constrained paraphrasing process is constrained such that the third augmented training data retains the entities from the original labeled sentence.

4. The computer-implemented method of claim 3, wherein the lexically constrained paraphrasing process uses back-translation to generate the third augmented training data.

5. The computer-implemented method of claim 1, wherein the constituency parsing process uses least common ancestor detection to generate the second augmented training data.

6. The computer-implemented method of claim 1, wherein the dependency parsing process uses shortest dependency path detection to generate the first augmented training data.

7. A computer-implemented method for training a relation extraction model using data augmentation of training data, the method comprising:
receiving an original labeled sentence as input, the labeled sentence including entities;
using a lexically constrained paraphrasing process on the labeled sentence to generate first augmented training data;
using a scoring function to order a training set, the training set including the original labeled sentence and the first augmented training data;
using a curriculum learning process to train the relation extraction model by feeding the scored training set to the machine learnable model; and
storing the trained relation extraction model in a memory.

8. The computer-implemented method of claim 7, wherein the lexically constrained paraphrasing process is constrained such that the first augmented training data retains the entities from the original labeled sentence.

9. The computer-implemented method of claim 7, wherein the lexically constrained paraphrasing process uses back-translation to generate the first augmented training data.

10. The computer-implemented method of claim 7, further comprising:
using a dependency parsing process on the labeled sentence to generate second augmented training data,
wherein the training set includes the original labeled sentence, the first augmented training data and the second augmented training data.

11. The computer-implemented method of claim 10, wherein the dependency parsing process uses shortest dependency path detection to generate the first augmented training data.

12. The computer-implemented method of claim 10, further comprising:
using a constituency parsing process on the labeled sentence to generate third augmented training data,
wherein the training set includes the original labeled sentence, the first augmented training data, the second augmented training data, and the third augmented training data.

13. The computer-implemented method of claim 12, wherein the constituency parsing process uses least common ancestor detection to generate the second augmented training data.

14. A computer-implemented method for training a machine learnable model using data augmentation of training data, the method comprising:
a) receiving an original labeled sentence as input, the labeled sentence including entities;
b) using at least one of a dependency parsing process, a constituency parsing process, and a lexically constrained paraphrasing process on the labeled sentence to generate augmented training data;
c) selecting a first scoring function from a plurality of scoring functions to order a training set based on difficulty, the training set including the original labeled sentence and the augmented training data;
d) training the relation extraction model using a curriculum learning process by feeding the scored training set to the relation extraction model in an order determined by the selected scoring function to generate an intermediate model;
e) determining a respective performance metric for each of the scoring functions in the plurality by evaluating a performance of the intermediate model using a validation data set ordered respectively by the plurality of scoring functions;
f) selecting another scoring function from the plurality of scoring functions to order the training set, the another scoring function being selected based on the determined performance metric of the second scoring function; and
g) training the relation extraction model again using the scored training set data from the another scoring function.

15. The method of claim 14, wherein steps f) and g) are repeated until convergence of the relation extraction model.

16. The method of claim 14, wherein the performance metric corresponds to negative correlation, such that the scoring function having a larger negative correlation is selected as the another scoring function.

17. The method of claim 15, wherein the plurality of scoring functions include at least a distance between two entities function, a sentence length function, a word rarity function, and a perplexity of sentence function.
